(19) United States
(12) Patent Application Publication
(10) Pub. No.: US 2012/0314440 A1
(43) Pub. Date: Dec. 13, 2012

(54) LED LIGHTING DEVICE

(75) Inventors: Leopold Hellinger, Ziersdorf (AT); Gerhard Neumann, St. Margarethen (AT); Gerald Vogt, Himberg (AT)

(73) Assignee: OSRAM AG, Muenchen (DE)

(21) Appl. No.: 13/516,247

(22) PCT Filed: Nov. 29, 2010
(86) PCT No.: PCT/EP2010/068366

§ 371 Date: Aug. 9, 2012

(30) Foreign Application Priority Data
Dec. 18, 2009 (DE) 10 2009 054 926.9

(51) Int. Cl. B60Q 1/04; H01J 9/24; F21V 29/00; F21V 21/00; F21V 7/00

(52) U.S. Cl. 362/516; 362/249.02; 362/545; 445/23

(57) ABSTRACT

A lighting device may include a circuit board, at least one light emitting diode fastened to the circuit board, and a housing, wherein the circuit board is a wall segment of the housing.

### TECHNICAL FIELD The invention is based on LED lighting devices.

### PRIOR ART

LED lighting devices, despite their improved efficiency compared to earlier lamps, generate waste heat which must be removed from the LEDs and the circuit board to which they are fastened.

Circuit boards with aluminum or metal core boards are known, via whose metal heat can be removed to a heat sink. Furthermore, according to the prior art such heat sinks are connected to a housing of the arrangement via special thermal bridges, e.g. foils or pastes. The disadvantage of LED lighting devices with heat dissipation concepts of this type is their cost in terms of device technology.

### SUMMARY OF THE INVENTION

The object of the present invention is to create an LED lighting device with a heat dissipation concept whose device technology costs are reduced.

This object is achieved by an LED lighting device according to claim 1 or by a method for its manufacture according to claim 11. The inventive LED lighting device has at least one LED fastened to a circuit board, and a housing, wherein the circuit board is a wall segment of the housing. Thus an effective heat dissipation concept is created, whose device technology costs are reduced.

Particularly advantageous embodiments are described in the dependent claims.

In a particularly preferred development the circuit board is or has a somewhat flat surface. This means that the mounting of LEDs and possibly of further components on the circuit board is simplified.

It is preferable if the circuit board and the housing consist of a uniform plastic, in particular a thermoplastic material.

In a particularly preferred development the circuit board is inserted into a recess of a wall of the housing, said circuit board having borders or edges via which it is firmly bonded to the wall, in particular by means of a friction welding process or an ultrasonic welding process, or by means of adhesive. Thus a simple, durable and material-saving bond is created between PCB and housing, via which the waste heat of the LEDs can be removed to the housing.

It is particularly preferable if at least two of said borders or edges of the circuit board are more or less parallel. Such circuit boards can be assembled with minimal production cost using automatic SMD placement systems, of which the working width for this purpose is adjusted to the distance between the borders or edges of the circuit board.

In particularly economically profitable applications, the inventive lighting device is a headlamp or a daytime running lamp of a vehicle.

In this case it is preferable if the lighting device has a reflector arrangement with a plurality of reflectors. If the vehicle headlamp is installed in the vehicle, the circuit board is disposed over or above the reflector arrangement, wherein each reflector has an LED or a power LED assigned to it.

In order to optimize the heat dissipation of the circuit board, the circuit board may also have cooling surfaces of copper alongside or between conducting paths.

In order to increase the thermal conductivity of the circuit board further, it may have recesses which are filled with solder.

The inventive method for manufacturing such a lighting device has the following stages:
chemical application of copper onto the PCB;
phototechnical deposition of a conductive pattern in the copper;
release etching of the areas of the conductive pattern that are not required;
galvanic copper plating of the conductive pattern;
conventional mounting on the circuit board of the LEDs or power LEDs and of other electronic components; and
bonding of the housing to the circuit board by means of friction welding, ultrasound bonding or adhesion.

Lighting devices manufactured in this way provide a relatively effective heat dissipation concept with a relatively low manufacturing cost.

In a particularly preferred development of the inventive method, after the release etching of the surfaces that are not required the conductive pattern is galvanically copper-plated.

In a particularly preferred development of the inventive method, the circuit board is assembled using an automatic SMD placement system and a reflow oven. Thus automated mass production is possible at comparatively low cost.

To increase the thermal conductivity of the circuit board further, the recesses of the circuit board may be filled with solder before assembly.

The conductive pattern is preferably galvanically copper-plated to a thickness of 50-100 μm.

### BRIEF DESCRIPTION OF DRAWINGS

The invention will be described in greater details below on the basis of an exemplary embodiment. In the diagrams,

FIG. 1 shows an exemplary embodiment of an inventive LED daytime running lamp;

FIG. 2 shows a section of the first exemplary embodiment of an inventive LED daytime running lamp without front cover; and

FIG. 3 shows a circuit board of the first exemplary embodiment of an inventive LED daytime running lamp;

FIG. 4 shows a cutaway perspective view of the first exemplary embodiment of an inventive LED daytime running lamp.

### PREFERRED EMBODIMENT OF THE INVENTION

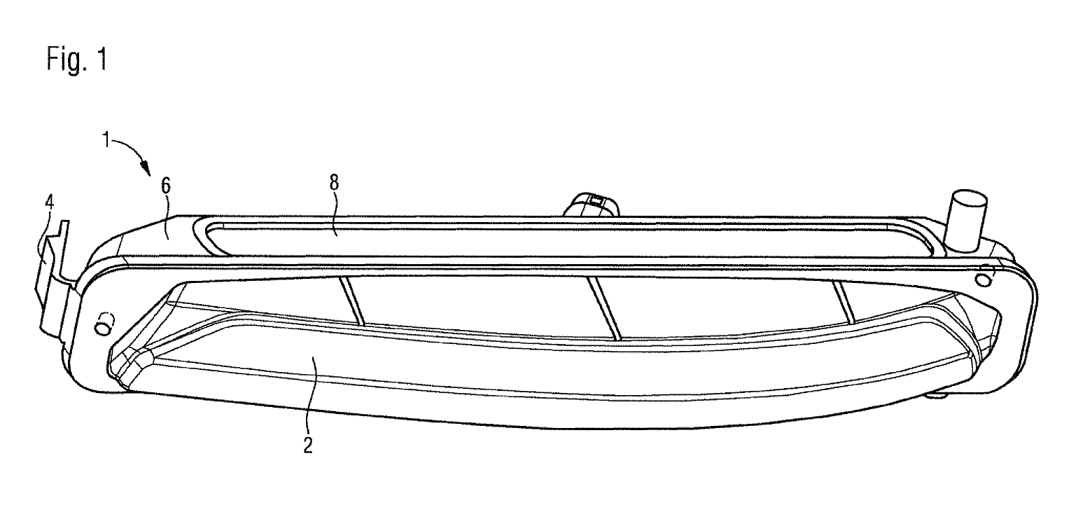

FIG. 1 shows a first exemplary embodiment of an inventive LED lighting device in a perspective view from above. The picture shows a daytime running lamp as a front light for a vehicle with four power LEDs.

The daytime running lamp has a housing 1, which has a more or less trough-shaped design and is covered and/or enclosed on its front side (in FIG. 1) by a translucent covering 2. The daytime running lamp is inserted into a corresponding recess on a front side of a vehicle (not shown in greater detail) where it is secured by means of a snap lock 4. Said cover 2, with its light emission aperture, is directed forward more or less in the direction of travel of the vehicle.

A lengthwise recess is provided on an upper wall 6 of the housing 1, into which is inserted a similarly shaped circuit board 8. The surrounding border or edge of the circuit board 8 and the border of the recess have a steplike design, wherein their surrounding bonding is effected by means of a friction welding process or an ultrasound welding process, or by means of adhesive.

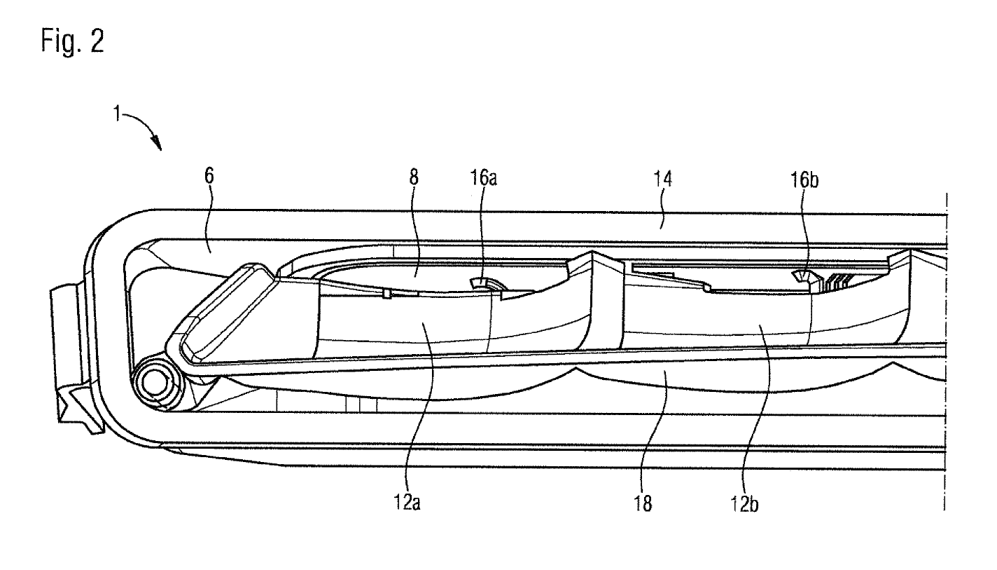

FIG. 2 shows a cutaway of the first exemplary embodiment of the inventive daytime running lamp without the front cover 2 in a perspective illustration viewed diagonally from below. The trough-shaped housing 1 has a frame section 14, which extends along the entire length of the daytime running lamp and to which the cover which is not shown (in FIG. 2) is fastened. A reflector arrangement 10 is incorporated in the housing 1, which essentially consists of four concave reflectors of which only two reflectors 12a, 12b are shown in FIG. 2.

In the perspective illustration according to FIG. 2 the upper wall 6 and the circuit board 8 of the inventive daytime running lamp are partially shown. The circuit board 8 is disposed above the reflectors 12a, 12b, so that power LEDs 16a, 16b mounted thereon can shine into the respectively assigned reflectors 12a, 12b and from there through the cover 2 more or less in the direction of travel of the vehicle.

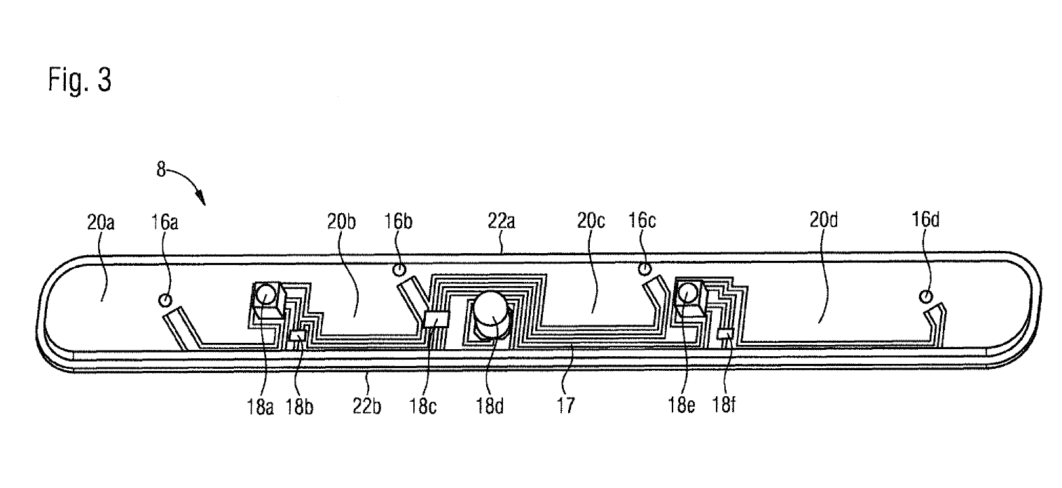

FIG. 3 shows the circuit board 8 of the inventive daytime running lamp viewed from below. The four power LEDs 16a-d are disposed on the underside shown, and are distributed more or less evenly across the circuit board 8 and diagonally to a longitudinal axis of the vehicle (not shown), while the two central power LEDs 16b, 16c are set slightly further forward (or higher up in FIG. 3) along the longitudinal axis of the vehicle.

Electrical conducting paths 17 and electronic components 18a-f for powering the power LEDs 16a-d are mounted on the circuit board 8.

Galvanic copper plating is used for supplying electricity to the power LEDs 16a-d, wherein free areas of the circuit board 8 that are not required by the conducting paths 17 are designed as cooling surfaces 20a-d. These cooling surfaces 20a-d are likewise produced by galvanic copper plating and are used for transferring the waste heat produced by the power LEDs 16a-d to the ambient air. Thus the circuit board 8 has a conductive pattern which consists both of the conducting paths 17 and of the cooling surfaces 20a-d.

In order that that the flat circuit board 8 can be mounted with minimal cost in an automatic SMD placement system, the circuit board 8 has two parallel edges 22a, 22b.

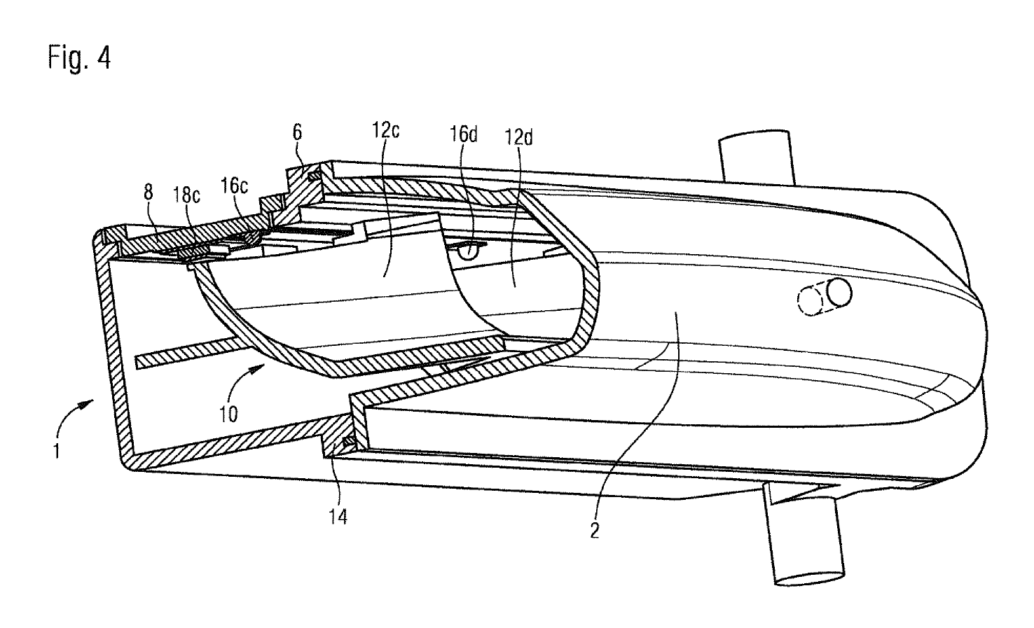

FIG. 4 shows a perspective view from below of a cross-section of the inventive daytime running lamp. The trough-shaped housing 1 with the frame section 14 to which the cover 2 is fitted is shown in cross-section therein.

The circuit board 8 is inserted into the recess with a steplike border on the upper wall 6, the size of said circuit board corresponding to that of the recess and its border or edge likewise having a steplike design. Comparatively large contact areas are thereby created between the circuit board 8 heated by the power LEDs 16a-d and the housing 1. In this way the waste heat from the power LEDs 16a-d can be dissipated both via the cooling surfaces 20a-d (cf. FIG. 3) to the air in the interior cavity of the daytime running lamp and via the contact surfaces to the housing 1.

1. A lighting device, comprising:
a circuit board;
at least one light emitting diode fastened to the circuit board; and
a housing;
wherein the circuit board is a wall segment of the housing.

2. The lighting device as claimed in claim 1, wherein the circuit board is or has a more or less flat surface.

3. The lighting device as claimed in claim 1, wherein the circuit board and the housing consist of a uniform plastic or thermoplastic.

4. The lighting device as claimed in claim 1,
wherein the circuit board is inserted into a recess of a wall of the housing, and
wherein the circuit board has borders or edges via which the circuit board is firmly bonded to the wall.

5. The lighting device as claimed in claim 4,
wherein the borders or edges of the circuit board are bonded to the wall via a friction welding process or an ultrasonic welding process, or by means of adhesive.

6. The lighting device as claimed in claim 5,
wherein at least two of the borders or edges of the circuit board are more or less parallel.

7. The lighting device as claimed in claim 1,
which is a headlamp or a daytime running lamp of a vehicle.

8. The lighting device as claimed in claim 7, further comprising:
a reflector arrangement which has a plurality of reflectors,
wherein the circuit board, when the vehicle headlight is installed, is disposed above the reflector arrangement, and
wherein each reflector is assigned a light emitting diode or a power light emitting diode.

9. The lighting device as claimed in claim 1,
wherein the circuit board has conducting paths and cooling surfaces of copper.

10. The lighting device as claimed in claim 1,
wherein the circuit board has recesses which are filled with solder.

11. A method for producing a lighting device, the lighting device comprising:
a circuit board;
at least one light emitting diode fastened to the circuit board; and
a housing;
wherein the circuit board is a wall segment of the housing;
the method comprising:
chemical application of copper onto the PCB;
phototechnical deposition of a conductive pattern in the copper;
release etching of the areas of the conductive pattern that are not required;
conventional mounting on the circuit board of the light emitting diodes or power light emitting diodes and of other electronic components; and
bonding of the housing to the circuit board by means of friction welding, ultrasound bonding or adhesion.

12. The method as claimed in claim 11,
wherein the conductive pattern is galvanically copper-plated after the release etching of the surfaces that are not required.

13. The method as claimed in claim 11, wherein the circuit board is assembled using an automatic SMD placement system and a reflow oven.

14. The method as claimed in claim 13,
wherein the recesses of the circuit board are filled with solder before the circuit board is assembled.

15. The method as claimed in claim 11,
wherein the conductive pattern is galvanically copper-plated to a thickness of 50-100 μm.
